(19) United States
(12) Patent Application Publication
(10) Pub. No.: US 2026/0228564 A1
(43) Pub. Date: Aug. 6, 2026

(54) System, Method, and Computer Program Product for Predictive Modeling Using Hyperbolic Knowledge Graph Embeddings

(71) Applicant: Visa International Service Association, San Francisco, CA (US)

(72) Inventors: Xiran Fan, San Mateo, CA (US); Minghua Xu, Austin, TX (US); Huiyuan Chen, San Jose, CA (US); Hao Yang, San Jose, CA (US)

(21) Appl. No.: 19/150,255

(22) PCT Filed: Jan. 24, 2024
(86) PCT No.: PCT/US24/12708

§ 371 Date: Jul. 23, 2025

Related U.S. Application Data
(60) Provisional application No. 63/440,991, filed on Jan. 25, 2023.

(51) Int. Cl. G06N 5/02; G06F 16/901

(52) U.S. Cl. CPC G06N 5/02; G06F 16/9024

(57) ABSTRACT

Described are a system, method, and computer program product for predictive modeling using hyperbolic knowledge graph embeddings. The method includes receiving graph data associated with a knowledge graph including at least one triple. The method also includes generating, in a hyperbolic space, a head embedding for each head vector, a tail embedding for each tail vector, and a relation embedding for each relation vector, of the at least one triple. The method further includes determining a score for each triple based on the head embedding, the tail embedding, and the relation embedding. The method further includes determining a loss based on the score for each triple and updating the head embedding, the tail embedding, and the relation embedding for each triple based on the loss. The method further includes repeating determining the score, determining the loss, and updating until a termination condition is satisfied.

### CROSS REFERENCE TO RELATED APPLICATIONS

This application is the United States national phase of International Application No. PCT/US24/12708, filed Jan. 24, 2024, and claims priority to U.S. Provisional Patent Application No. 63/440,991, filed Jan. 25, 2023, the disclosures of which are hereby incorporated by reference in their entireties.

### BACKGROUND

### 1. Technical Field

This disclosure relates generally to predictive machine learning models and, in non-limiting embodiments or aspects, to systems, methods, and computer program products for predictive modeling using hyperbolic knowledge graph embeddings.

### 2. Technical Considerations

Knowledge graphs may represent relationships between entities, e.g., as edges connecting nodes and/or the like. It may be useful to map the nodes and/or edges of the knowledge graph into a representation space, e.g., to model relationship patterns and/or the like.

However, Euclidian representation spaces may be computationally complex, e.g., for representing higher-order hierarchical relationship data. Increased computational complexity in the representation space increases time and/or computing resources (e.g., memory, bandwidth, processing capacity, etc.) to train predictive models for the knowledge graph. Knowledge graphs with hierarchical relationships between entities may also be difficult to map to a representation space because there is often not sufficient space for the mapping. The dimensionality of an embedding vector in the representation space, e.g., a Euclidean space, may require excessive computing resources. Additionally, with higher-order layers of hierarchical relationship data, the most distal entities of a tree structure of the knowledge graph may become overly densely populated at the periphery, reducing salience in the representation space.

### SUMMARY

Accordingly, provided are improved systems, methods, and computer program products for predictive modeling using hyperbolic knowledge graph embeddings.

According to non-limiting embodiments or aspects, provided is a system for predictive modeling using hyperbolic knowledge graph embeddings. The system includes at least one processor configured to receive graph data associated with a knowledge graph including a plurality of nodes and a plurality of edges. Each node of the plurality of nodes is associated with an entity of a plurality of entities. Each edge of the plurality of edges is associated with a relationship between at least two of the plurality of entities. The knowledge graph includes at least one triple. Each respective triple includes a respective head vector associated with a first respective entity of the plurality of entities, a respective tail vector associated with a second entity of the plurality of entities, and a respective relation vector associated with a respective relationship between the first respective entity and the second respective entity. The at least one processor is also configured to generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple. The at least one processor is further configured to determine a respective score for each respective triple of the at least the subset of the at least one triple based on the respective head embedding, the respective tail embedding, and the respective relation embedding. The at least one processor is further configured to determine a loss based on the respective score for each respective triple of the at least the subset of the at least one triple. The at least one processor is further configured to update the respective head embedding, the respective tail embedding, and the respective relation embedding for each respective triple of the at least the subset of the at least one triple based on the loss. The at least one processor is further configured to repeat determining the respective score, determining the loss, and updating until a termination condition is satisfied.

In some non-limiting embodiments or aspects, when determining the loss, the at least one processor may be configured to, at least one of: generate a recovered head embedding based on the respective tail embedding, the respective relation embedding, and the loss; or generate a recovered tail embedding based on the respective head embedding, the respective relation embedding, and the loss.

In some non-limiting embodiments or aspects, the termination condition may be a convergence of the loss. The at least one processor may be further configured to, in response to the convergence of the loss, generate a prediction from a predictive model based on updating the respective head embedding, the respective tail embedding, and the respective relation embedding. Additionally or alternatively, the at least one processor may be further configured to, in response to the convergence of the loss, determine a new score for a new triple including at least one of a new head vector, a new tail vector, or a new relation vector.

In some non-limiting embodiments or aspects, the graph data may be at least partly based on user interactions of at least one user in a network, and the prediction may be associated with a predicted relationship between a user of the at least one user and another entity in the network.

In some non-limiting embodiments or aspects, the plurality of entities may include a plurality of types of entities, the plurality of types of entities including at least a user type entity and a network resource type entity. Relationships between user type entities and network resource type entities may be associated with access of a network resource by a user.

According to non-limiting embodiments or aspects, provided is a computer-implemented method for predictive modeling using hyperbolic knowledge graph embeddings. The method includes receiving, with at least one processor, graph data associated with a knowledge graph including a plurality of nodes and a plurality of edges. Each node of the plurality of nodes is associated with an entity of a plurality of entities. Each edge of the plurality of edges is associated with a relationship between at least two of the plurality of entities. The knowledge graph includes at least one triple. Each respective triple includes a respective head vector associated with a first respective entity of the plurality of entities, a respective tail vector associated with a second entity of the plurality of entities, and a respective relation vector associated with a respective relationship between the first respective entity and the second respective entity. The method also includes generating, with at least one processor, a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple. The method further includes determining, with at least one processor, a respective score for each respective triple of the at least the subset of the at least one triple based on the respective head embedding, the respective tail embedding, and the respective relation embedding. The method further includes determining, with at least one processor, a loss based on the respective score for each respective triple of the at least the subset of the at least one triple. The method further includes updating, with at least one processor, the respective head embedding, the respective tail embedding, and the respective relation embedding for each respective triple of the at least the subset of the at least one triple based on the loss. The method further includes repeating, with at least one processor, determining the respective score, determining the loss, and updating until a termination condition is satisfied

In some non-limiting embodiments or aspects, determining the loss may include at least one of: generating, with at least one processor, a recovered head embedding based on the respective tail embedding, the respective relation embedding, and the loss; or generating, with at least one processor, a recovered tail embedding based on the respective head embedding, the respective relation embedding, and the loss.

In some non-limiting embodiments or aspects, the termination condition may be a convergence of the loss. The method may further include, in response to the convergence of the loss, generating, with at least one processor, a prediction from a predictive model based on updating the respective head embedding, the respective tail embedding, and the respective relation embedding. Additionally or alternatively, the method may further include, in response to the convergence of the loss, determining, with at least one processor, a new score for a new triple including at least one of a new head vector, a new tail vector, or a new relation vector.

In some non-limiting embodiments or aspects, the graph data may be at least partly based on user interactions of at least one user in a networked system, and the prediction may be associated with a predicted relationship between a user of the at least one user and another entity in the networked system.

In some non-limiting embodiments or aspects, the plurality of entities may include a plurality of types of entities, the plurality of types of entities including at least a user type entity and a network resource type entity. Relationships between user type entities and network resource type entities may be associated with access of a network resource by a user.

According to non-limiting embodiments or aspects, provided is a computer program product for predictive modeling using hyperbolic knowledge graph embeddings. The computer program product includes at least one non-transitory computer-readable medium including program instructions that, when executed by at least one processor, cause the at least one processor to receive graph data associated with a knowledge graph including a plurality of nodes and a plurality of edges. Each node of the plurality of nodes is associated with an entity of a plurality of entities. Each edge of the plurality of edges is associated with a relationship between at least two of the plurality of entities. The knowledge graph includes at least one triple. Each respective triple includes a respective head vector associated with a first respective entity of the plurality of entities, a respective tail vector associated with a second entity of the plurality of entities, and a respective relation vector associated with a respective relationship between the first respective entity and the second respective entity. The program instructions also cause the at least one processor to generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple. The program instructions further cause the at least one processor to determine a respective score for each respective triple of the at least the subset of the at least one triple based on the respective head embedding, the respective tail embedding, and the respective relation embedding. The program instructions further cause the at least one processor to determine a loss based on the respective score for each respective triple of the at least the subset of the at least one triple. The program instructions further cause the at least one processor to update the respective head embedding, the respective tail embedding, and the respective relation embedding for each respective triple of the at least the subset of the at least one triple based on the loss. The program instructions further cause the at least one processor to repeat determining the respective score, determining the loss, and updating until a termination condition is satisfied.

In some non-limiting embodiments or aspects, the program instructions that cause the at least one processor to determine the loss may cause the at least one processor to, at least one of: generate a recovered head embedding based on the respective tail embedding, the respective relation embedding, and the loss; or generate a recovered tail embedding based on the respective head embedding, the respective relation embedding, and the loss.

In some non-limiting embodiments or aspects, the termination condition may be a convergence of the loss. The program instructions may further cause the at least one processor to, in response to the convergence of the loss, generate a prediction from a predictive model based on updating the respective head embedding, the respective tail embedding, and the respective relation embedding. Additionally or alternatively, the program instructions may further cause the at least one processor to, in response to the convergence of the loss, determine a new score for a new triple including at least one of a new head vector, a new tail vector, or a new relation vector.

In some non-limiting embodiments or aspects, the graph data may be at least partly based on user interactions of at least one user in a network, and the prediction may be associated with a predicted relationship between a user of the at least one user and another entity in the network.

Further non-limiting embodiments or aspects are set forth in the following numbered clauses:

Clause 1: A system comprising: at least one processor configured to: receive graph data associated with a knowledge graph comprising a plurality of nodes and a plurality of edges, each node of the plurality of nodes associated with an entity of a plurality of entities, each edge of the plurality of edges associated with a relationship between at least two of the plurality of entities, the knowledge graph comprising at least one triple, each respective triple comprising a respective head vector associated with a first respective entity of the plurality of entities, a respective tail vector associated with a second entity of the plurality of entities, and a respective relation vector associated with a respective relationship between the first respective entity and the second respective entity; generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple; determine a respective score for each respective triple of the at least the subset of the at least one triple based on the respective head embedding, the respective tail embedding, and the respective relation embedding; determine a loss based on the respective score for each respective triple of the at least the subset of the at least one triple; update the respective head embedding, the respective tail embedding, and the respective relation embedding for each respective triple of the at least the subset of the at least one triple based on the loss; and repeat determining the respective score, determining the loss, and updating until a termination condition is satisfied.

Clause 2: The system of clause 1, wherein, when determining the loss, the at least one processor is configured to, at least one of: generate a recovered head embedding based on the respective tail embedding, the respective relation embedding, and the loss; or generate a recovered tail embedding based on the respective head embedding, the respective relation embedding, and the loss.

Clause 3: The system of clause 1 or clause 2, wherein the termination condition is a convergence of the loss.

Clause 4: The system of any of clauses 1-3, wherein the at least one processor is further configured to, in response to the convergence of the loss, generate a prediction from a predictive model based on updating the respective head embedding, the respective tail embedding, and the respective relation embedding.

Clause 5: The system of any of clauses 1-4, wherein the at least one processor is further configured to, in response to the convergence of the loss, determine a new score for a new triple comprising at least one of a new head vector, a new tail vector, or a new relation vector.

Clause 6: The system of any of clauses 1-5, wherein the graph data is at least partly based on user interactions of at least one user in a network, and wherein the prediction is associated with a predicted relationship between a user of the at least one user and another entity in the network.

Clause 7: The system of any of clauses 1-6, wherein the plurality of entities comprise a plurality of types of entities, the plurality of types of entities comprising at least a user type entity and a network resource type entity, wherein relationships between user type entities and network resource type entities are associated with access of a network resource by a user.

Clause 8: A computer-implemented method comprising: receiving, with at least one processor, graph data associated with a knowledge graph comprising a plurality of nodes and a plurality of edges, each node of the plurality of nodes associated with an entity of a plurality of entities, each edge of the plurality of edges associated with a relationship between at least two of the plurality of entities, the knowledge graph comprising at least one triple, each respective triple comprising a respective head vector associated with a first respective entity of the plurality of entities, a respective tail vector associated with a second entity of the plurality of entities, and a respective relation vector associated with a respective relationship between the first respective entity and the second respective entity; generating, with at least one processor, a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple; determining, with at least one processor, a respective score for each respective triple of the at least the subset of the at least one triple based on the respective head embedding, the respective tail embedding, and the respective relation embedding; determining, with at least one processor, a loss based on the respective score for each respective triple of the at least the subset of the at least one triple; updating, with at least one processor, the respective head embedding, the respective tail embedding, and the respective relation embedding for each respective triple of the at least the subset of the at least one triple based on the loss; and repeating, with at least one processor, determining the respective score, determining the loss, and updating until a termination condition is satisfied.

Clause 9: The method of clause 8, wherein determining the loss comprises at least one of: generating, with at least one processor, a recovered head embedding based on the respective tail embedding, the respective relation embedding, and the loss; or generating, with at least one processor, a recovered tail embedding based on the respective head embedding, the respective relation embedding, and the loss.

Clause 10: The method of clause 8 or clause 9, wherein the termination condition is a convergence of the loss.

Clause 11: The method of any of clauses 8-10, further comprising, in response to the convergence of the loss, generating, with at least one processor, a prediction from a predictive model based on updating the respective head embedding, the respective tail embedding, and the respective relation embedding.

Clause 12: The method of any of clauses 8-11, further comprising, in response to the convergence of the loss, determining, with at least one processor, a new score for a new triple comprising at least one of a new head vector, a new tail vector, or a new relation vector.

Clause 13: The method of any of clauses 8-12, wherein the graph data is at least partly based on user interactions of at least one user in a networked system, and wherein the prediction is associated with a predicted relationship between a user of the at least one user and another entity in the networked system.

Clause 14: The method of any of clauses 8-13, wherein the plurality of entities comprise a plurality of types of entities, the plurality of types of entities comprising at least a user type entity and a network resource type entity, wherein relationships between user type entities and network resource type entities are associated with access of a network resource by a user.

Clause 15: A computer program product comprising at least one non-transitory computer-readable medium comprising program instructions that, when executed by at least one processor, cause the at least one processor to: receive graph data associated with a knowledge graph comprising a plurality of nodes and a plurality of edges, each node of the plurality of nodes associated with an entity of a plurality of entities, each edge of the plurality of edges associated with a relationship between at least two of the plurality of entities, the knowledge graph comprising at least one triple, each respective triple comprising a respective head vector associated with a first respective entity of the plurality of entities, a respective tail vector associated with a second entity of the plurality of entities, and a respective relation vector associated with a respective relationship between the first respective entity and the second respective entity; generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple; determine a respective score for each respective triple of the at least the subset of the at least one triple based on the respective head embedding, the respective tail embedding, and the respective relation embedding; determine a loss based on the respective score for each respective triple of the at least the subset of the at least one triple; update the respective head embedding, the respective tail embedding, and the respective relation embedding for each respective triple of the at least the subset of the at least one triple based on the loss; and repeat determining the respective score, determining the loss, and updating until a termination condition is satisfied.

Clause 16: The computer program product of clause 15, wherein the program instructions that cause the at least one processor to determine the loss cause the at least one processor to, at least one of: generate a recovered head embedding based on the respective tail embedding, the respective relation embedding, and the loss; or generate a recovered tail embedding based on the respective head embedding, the respective relation embedding, and the loss.

Clause 17: The computer program product of clause 15 or clause 16, wherein the termination condition is a convergence of the loss.

Clause 18: The computer program product of any of clauses 15-17, wherein the program instructions further cause the at least one processor to, in response to the convergence of the loss, generate a prediction from a predictive model based on updating the respective head embedding, the respective tail embedding, and the respective relation embedding.

Clause 19: The computer program product of any of clauses 15-18, wherein the program instructions further cause the at least one processor to, in response to the convergence of the loss, determine a new score for a new triple comprising at least one of a new head vector, a new tail vector, or a new relation vector.

Clause 20: The computer program product of any of clauses 15-19, wherein the graph data is at least partly based on user interactions of at least one user in a network, and wherein the prediction is associated with a predicted relationship between a user of the at least one user and another entity in the network.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for predictive modeling using hyperbolic knowledge graph embeddings, according to some non-limiting embodiments or aspects;

FIG. 2 is a schematic diagram of example components of one or more devices of FIG. 1, according to some non-limiting embodiments or aspects;

FIG. 3 is a flow diagram of a method for predictive modeling using hyperbolic knowledge graph embeddings, according to some non-limiting embodiments or aspects;

FIG. 4 is an illustrative diagram of a knowledge graph that may be used in methods for predictive modeling using hyperbolic knowledge graph embeddings, according to some non-limiting embodiments or aspects;

FIG. 5A is an illustrative diagram of a triple in Euclidean space, associated with methods for predictive modeling using hyperbolic knowledge graph embeddings, according to some non-limiting embodiments or aspects;

FIG. 5B is an illustrative diagram of the triple of FIG. 5A transformed into hyperbolic space, associated with methods for predictive modeling using hyperbolic knowledge graph embeddings, according to some non-limiting embodiments or aspects; and

FIG. 6 is a schematic diagram of an electronic payment processing network, for use with methods for predictive modeling using hyperbolic knowledge graph embeddings, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

The systems, methods, and computer program products described herein provide numerous technical advantages in systems for predictive modeling using hyperbolic knowledge graph embeddings. For example, hyperbolic space may embed tree-like data (e.g., hierarchical data) more accurately and efficiently than Euclidean space. The computational resources (e.g., memory, bandwidth, processing capacity, etc.) required for training predictive models is reduced by training the models with representations of knowledge graph entities in a hyperbolic embedding space, e.g., as compared to a Euclidean embedding space. Hyperbolic space provides more space for hierarchical representations between entities. For example, a hyperbolic embedding space may require a vector with fewer dimensions to represent the same entity as a vector in Euclidean space. In a further example, knowledge graphs with hierarchical relationships grow in complexity (e.g., number of nodes) exponentially with each additional hierarchical layer, which may be computational intensive to represent in Euclidean space. Because distance between points in hyperbolic space is measured along a curve rather than a line, hierarchical embeddings of knowledge graphs maintain greater salience toward the deeper layers of the hierarchy and reduce graph density at the furthest points of the graphs. Furthermore, the described systems and methods improve over approximation techniques, which may use exponential function maps to convert representations in a tangent space to hyperbolic space and logarithmic function maps to convert representations in the hyperbolic space to the tangent space. Such approximation techniques may cause distortion and affect overall model performance. The described system and methods avoid the distortion caused by approximation techniques. Additionally, the predictive modeling using hyperbolic knowledge graph embeddings described herein demonstrates improved performance compared to other techniques.

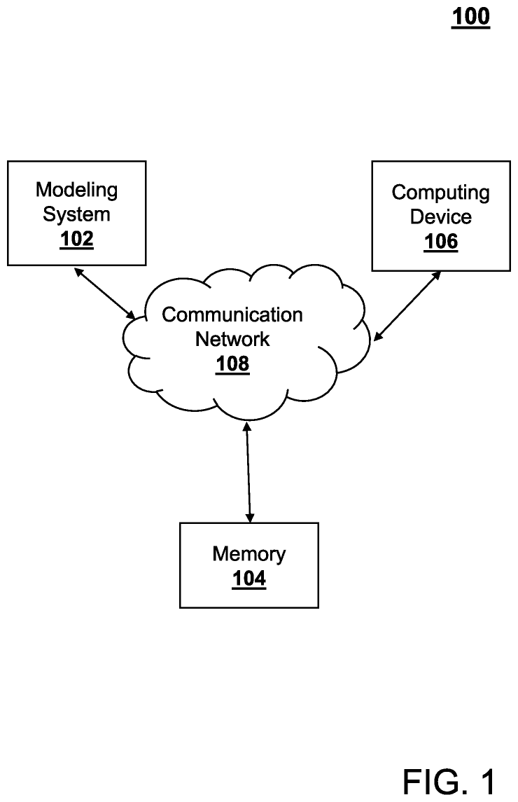

Referring now to FIG. 1, FIG. 1 is a schematic diagram of an example system 100 in which devices, systems, and/or methods, described herein, may be implemented. As shown in FIG. 1, system 100 may include modeling system 102, memory 104, computing device 106, and communication network 108. Modeling system 102, memory 104, and computing device 106 may interconnect (e.g., establish a connection to communicate) via wired connections, wireless connections, or a combination of wired and wireless connections. In some non-limiting embodiments or aspects, system 100 may further include a natural language processing system, an advertising system, a fraud detection system, a transaction processing system, a merchant system, an acquirer system, an issuer system, and/or a payment device.

Modeling system 102 may include one or more computing devices configured to communicate with memory 104 and/or computing device 106 at least partly over communication network 108. Modeling system 102 may be configured to receive data to train one or more machine learning models and/or to use one or more trained machine learning models to generate an output. Modeling system 102 may include or be in communication with memory 104. Modeling system 102 may be associated with, or included in a same system as, a natural language processing system, a fraud detection system, a product recommendation system, and/or a transaction processing system.

In some non-limiting embodiments or aspects, modeling system 102 may be implemented within or in connection with an electronic payment processing network. As an example, system 100 and modeling system 102 may be used to predict fraud in a payment transaction by assigning a PAN as head vectors, user identifiers (e.g., such as an email address) as tail vectors, and predicting the link (e.g., a relation) between a given head vector and a given tail vector. As another example, system 100 and modeling system 102 may be used to recommend one or more products/services and/or generate an automated offer by assigning any user identifier (e.g., PAN, email address, name, and/or the like) as a head vector and assigning the product (e.g., by product identifier or the like) as the tail vector, such that modeling system 102 is configured to predict the link (e.g., relation) between the head vector and the tail vector to determine if the product should be recommended or targeted. In a further example, system 100 and modeling system 102 may be used to predict a next word or phrase in a natural language processing system by assigning a first word or phrase as a head vector and assigning a directly following word or phrase as the tail vector, such that modeling system 102 is configured to predict the link (e.g., relation) between the head vector and the tail vector to determine a next recommended word to continue and/or complete a phrase.

Memory 104 may include one or more computing devices configured to communicate with modeling system 102 and/or computing device 106 at least partly over communication network 108. Memory 104 may be configured to store data associated with knowledge graphs, e.g., entity data of entities (e.g., represented by nodes) and/or relationship data associated with relationships between entities (e.g., represented by edges connecting two of the nodes), in one or more non-transitory computer readable storage media. Memory 104 may communicate with and/or be included in modeling system 102.

Computing device 106 may include one or more processors that are configured to communicate with modeling system 102 and/or memory 104 at least partly over communication network 108. Computing device 106 may be associated with a user and may include at least one user interface for transmitting data to and receiving data from modeling system 102 and/or memory 104. For example, computing device 106 may show, on a display of computing device 106, one or more outputs of machine learning models executed by modeling system 102. By way of further example, one or more inputs for machine learning models may be determined or received by modeling system 102 via a user interface of computing device 106.

Communication network 108 may include one or more wired and/or wireless networks over which the systems and devices of system 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of system 100 may perform one or more functions described as being performed by another set of devices of system 100.

In some non-limiting embodiments or aspects, modeling system 102 may receive graph data associated with a knowledge graph including a plurality of nodes (e.g., vertices) and a plurality of edges (e.g., connections). Each node of the plurality of nodes may be associated with an entity of a plurality of entities (e.g., users, devices, resources, features, parameters, and/or the like in a graphed domain). Each edge of the plurality of edges may be associated with a relationship between at least two of the plurality of entities (e.g., a causal relationship, an interaction relationship, a correlation relationship, a dependency relationship, a subset relationship, and/or the like). The knowledge graph may include at least one triple (e.g., a head vector, a tail vector, and a relation vector between the head vector and the tail vector). Each respective triple may include a respective head vector associated with a first respective entity of the plurality of entities, a respective tail vector associated with a second entity of the plurality of entities, and a respective relation vector associated with a respective relationship between the first respective entity and the second respective entity.

In some non-limiting embodiments or aspects, modeling system 102 may generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple. Modeling system 102 may determine a respective score for each respective triple of the at least the subset of the at least one triple based on the respective head embedding, the respective tail embedding, and the respective relation embedding (see, e.g., Formula 13, described below). Modeling system 102 may determine a loss based on the respective score for each respective triple of the at least the subset of the at least one triple (see, e.g., Formula 14, described below). Modeling system 102 may update the respective head embedding, the respective tail embedding, and the respective relation embedding for each respective triple of the at least the subset of the at least one triple based on the loss (e.g., by recovering either a head embedding or a tail embedding based on the remaining two embeddings of an embedded triple and the loss function). Modeling system 102 may repeat determining the respective score, determining the loss, and updating until a termination condition is satisfied (e.g., convergence of loss).

In some non-limiting embodiments or aspects, determining the loss may include at least one of generating (e.g., by modeling system 102) a recovered head embedding based on the respective tail embedding, the respective relation embedding, and/or the loss, or generating (e.g., by modeling system 102) a recovered tail embedding based on the respective head embedding, the respective relation embedding, and/or the loss.

In some non-limiting embodiments or aspects, modeling system 102 may repeatedly determine the respective score, determine the loss, and update the respective head embedding, the respective tail embedding, and the respective relation embedding for each respective triple of the at least the subset of the at least one triple based on the loss until a termination condition is satisfied (e.g., a convergence of the loss, a target number of repetitions, and/or the like). After the termination condition is satisfied (e.g., in response to the convergence of the loss), modeling system 102 may generate a prediction from a predictive model, determine a new score for a new triple, and/or the like, as described herein.

In some non-limiting embodiments or aspects, the graph data received by modeling system 102 may be at least partly based on (e.g., derived from network activity records) of at least one user in a network (e.g., a secured computer network, a media streaming network, a marketplace network, and/or the like). The prediction generated by modeling system 102 may be associated with a predicted relationship between a user and another entity in the network. For example, in a secured computer network, the predicted relationship may be a predicted malicious access request by a user for a computer resource entity in the network. By way of another example, in a media streaming network, the predicted relationship may be a predicted interest by a user to listen to a song entity in the network. By way of another example, in a marketplace network, the predicted relationship may be a predicted desire to purchase an item entity by a user entity. It will be appreciated that many configurations exist for various networks.

In some non-limiting embodiments or aspects, the plurality of entities in the knowledge graph may include a plurality of types of entities. For example, the plurality of types of entities may include at least a user type entity and a network resource type entity. Relationships between user type entities and network resource type entities may be associated with access of a network resource by a user. For example, in a secured computer network, the relationship may represent a user accessing a computer resource (e.g., a server, a computing device, a database, etc.) in the network. By way of another example, in a media streaming network, the relationship may represent a user accessing a song resource (e.g., a streaming media file) in the network. By way of another example, in a marketplace network, the relationship may represent a user accessing an item listing resource (e.g., a web page hosting an offered item). It will be appreciated that many configurations exist for various networks.

With further reference to FIG. 1, modeling system 102 may execute a series of steps to transform Euclidean vector representations of knowledge graphs into hyperbolic representations. For example, knowledge graphs may include a plurality of triples. Each triple may include a head vector, a tail vector, and a relation vector. Such knowledge graphs may be useful for question answering, information extraction, and recommendation systems. For such applications, knowledge graph embeddings may be generated by mapping entities and their relationships into a representation space while capturing their semantic meanings. Hyperbolic spaces as representation spaces provide the technical advantage of being able to embed tree-like data more accurately and efficiently than other representation spaces, such as Euclidian space. For the systems and methods described herein, a fully hyperbolic hierarchy-aware knowledge-graph-embedding model may be employed. For example, the Lorentz model-which models hyperbolic space—may be used as the representation space for entities, and the Lorentz group (e.g., the isometry group of the Lorentz model), may be used as the representation space for relations.

By way of further example, given the entity set ε and relation set [symbol] , a knowledge graph may be formally defined as a collection of factual triples [symbol] =((h,r,t)}, where h represents head entities, t represents tail entities, and r represents a relationship between h and t. Moreover, h,t∈ε and r∈ [symbol] . To predict missing links, modeling system 102 may map entities and relationships to distributed representations in some representation space [symbol] , and may define a score function fᵣ(h,t) to measure the plausibility of each triple. The score function may be based on various metrics, such as distance, inner product, and/or the like.

Hyperbolic space is a Riemannian manifold with constant negative curvature. Isometric models that may be used to model hyperbolic space include, but are not limited to, the Lorentz (e.g., hyperboloid) model, the Poincaré ball model, the Poincare half space model, the Klein model, and the hemisphere model. For purposes of illustration, the described mathematical representations below use the Lorentz model, which is regarded as a homogenous Riemannian manifold of the Lorentz group.

Lorentzian space may be defined as described below. The (n+1)-dimensional Lorentzian space [symbol] is the Euclidian space [symbol] equipped with a non-positive-definite bilinear form:

[symbol]

$${〈 x , y 〉}_{𝕃} = - {x}_{0} {y}_{0} + {x}_{1} {y}_{1} + … + {x}_{n} {y}_{n} \qquad Formula 1$$

where x and y are coordinates such that x=[x₀, x₁, . . . , xₙ]^{T}, y=[y₀, y₁, . . . , yₙ]^{T} ∈ [symbol] , and where the bilinear form [symbol] is the Lorentzian inner product. Lorentz space is related, in certain applications, to special relativity where the first coordinate x₀ corresponds to the time axis and the remaining coordinates correspond to the space axes.

The n-dimensional Lorentz model [symbol] is a submanifold in [symbol] and may be defined as:

$${𝕃}^{n} := \{ x = {[ {x}_{0} , … , {x}_{n} ]}^{T} ∈ {ℝ}^{n + 1} : {〈 x , x 〉}_{𝕃} = - 1 , {x}_{0} > 0 \} \qquad Formula 2$$

where T is the transposition function. The Lorentz model is the upper sheet of the two-sheeted n-dimensional hyperboloid in [symbol] .

The geodesic distance, also referred to as the length of the shortest path (e.g., a curve in hyperbolic space), in the Lorentz model is given by:

$${d}_{𝕃} ( x , y ) = {cosh}^{- 1} ( - {〈 x , y 〉}_{𝕃} ) \qquad Formula 3$$

for x,y∈ [symbol] , where cosh( ) is the hyperbolic cosine function, and where d represents geodesic distance.

Lorentzian transformation is a geometric transformation of Lorentzian space that preserves the Lorentzian inner product between every pair of points. Modeling system 102 may define map φ: [symbol] as a Lorentz transformation if [symbol] φ(x), φ(y) [symbol] is equal to [symbol] for any x, y∈ [symbol] . All Lorentz transformations form a group under composition. This group is called the Lorentz group, denoted by O(1, n), where O( ) is Big O notation. Modeling system 102 may define Jₙ=diag(−1, Iₙ) where Iₙ is the n×n identity matrix of size n, and diag( ) denotes a diagonal matrix. The Lorentz group may be defined as:

$$O ( 1 , n ) := \{ A ∈ G L ( n + 1 , ℝ ) : {AJ}_{n} {A}^{T} = {A}^{T} {J}_{n} A = {J}_{n} \} \qquad Formula 4$$

where GL(n+1, [symbol] ) is the general linear group of (n+1)×(n+1)-invertible matrices over [symbol] , where [symbol] is the set of real numbers.

There are a number of subgroups of the Lorentz group O(1, n). The special Lorentz group may be denoted by:

$$SO ( n ) := \{ A ∈ O ( 1 , n ) : det ( A ) = 1 \} \qquad Formula 5$$

where det( ) is the determinant and A is a matrix in the Lorentz group O(1, n). The positive Lorentz group may be denoted by:

$${O}^{+} ( 1 , n ) := \{ A ∈ O ( 1 , n ) : {a}_{11} > 0 \} \qquad Formula 6$$

where a₁₁ is the element in the first position of matrix A. The positive special Lorentz group may be denoted by:

$${SO}^{+} ( 1 , n ) := \{ A ∈ SO ( 1 , n ) : {a}_{11} > 0 \} \qquad Formula 7$$

The special Lorentz group preserves the orientation while the positive Lorentz group preserves the first entry of x∈ [symbol] .

Homogenous space may be defined as described below. Homogenous space is a space with a transitive group action by a Lie group. In hyperbolic space, the positive special Lorentz group SO⁺(1, n) acts transitively on [symbol] where the group action is defined

$$x ↦ Ax for x ∈ {𝕃}^{n} \qquad Formula 8$$

and A∈SO⁺(1, n). Under this group action, modeling system 102 may further identity the Lorentz model as the quotient space denoted by:

$${𝕃}^{n} ≅ {SO}^{+} ( 1 , n ) / SO ( n ) , \qquad Formula 9$$

where SO(n) is the group of n×n special orthogonal matrices. SO⁺(1, n) may be called the isometric group of the Lorentz model, and SO(n) may be called the isotropy group of the Lorentz model.

A Lorentz transformation A∈SO⁺(1, n) may be decomposed using a polar decomposition and expressed as:

$$A = [ \begin{matrix}1 & 0 \\ 0 & R\end{matrix} ] [ \begin{matrix}c & {v}^{T} \\ v & \sqrt{{I}_{n} + v {v}^{T}}\end{matrix} ] \qquad Formula 10$$

where R∈SO(n), v∈ [symbol] , and c is defined by:

$$c = \sqrt{{‖ v ‖}^{2} + 1} \qquad Formula 11$$

The first component in the decomposition of Formula 10 may be called the Lorentz rotation and the second component of Formula 10 may be called the Lorentz boost.

Modeling system 102 may use a score function for knowledge graph embeddings in hyperbolic space. Modeling system 102 may use the Lorentz model and Lorentz transformation to model entities and relationships in knowledge graphs. Modeling system 102 may make use of a hyperbolic analogue of the Euclidean inner product formula in the score function. For example, the Euclidean inner product may be expressed as a function of Euclidean distance and norms, such as:

$$〈 x , y 〉 = \frac{1}{2} ( - {{d}_{ℝ} ( x , y )}^{2} + {‖ x ‖}^{2} + {‖ y ‖}^{2} ) , \\ {d}_{ℝ} ( x , y ) = ‖ x - y ‖ , x , y , ∈ {ℝ}^{n} \qquad Formula 12$$

The hyperbolic analogue of Formula 12 (above) may replace the Euclidian distance with hyperbolic distance. Modeling system 102 may, therefore, define a score function for relational graph embedding as:

$${f}_{r} ( h , t ) = - {( {d}_{𝕃} ( {Λ}_{r , 1} h , {Λ}_{r , 2} t ) )}^{2} + {b}_{h} + {b}_{t} + δ \qquad Formula 13$$

where h,t∈ [symbol] are entity embeddings in the Lorentz model, Λ_{r,1}, Λ_{r,2} ∈SO⁺(1, k) are relations matrices, bₕ, bₜ ∈ [symbol] are scalar biases of head entity hand tail entity t, respectively, and δ∈ [symbol] is margin and d_{L} is the hyperbolic distance function shown in Formula 3 (above). In this manner, transformed entities Λ_{r,1} h, Λ_{r,2} t∈ [symbol] since Λ_{r,1} h, Λ_{r,2} ∈SO⁺(1, k).

In view of the above, modeling system 102 embeds head entity h and tail entity t in the Lorentz model, and further uses transformation matrices to model relation r. If (h,r,t) is a valid fact, then the transformed h and t (by relation r) should become closer together, and if (h,r,t) is not a valid fact, then the distance between transformed h and t will be comparatively larger. By that configuration, modeling system 102 may apply relation-specified transformations to head entities and tail entities, and measure the distance in specific space between transformed entities.

Modeling system 102 may further use a loss function to train the predictive model. For example, modeling system 102 may use negative sampling loss functions with self-adversarial training, as defined by:

$$L = - log ( σ ( λ - {f}_{r} ( h , t ) ) ) - \sum p ( {h}_{i}^{′} , {r}_{i} , {t}_{i}^{′} ) log ( σ ( {f}_{r} ( {h}_{i}^{′} , {t}_{i}^{′} ) - λ ) ) \qquad Formula 14$$

where λ is a fixed margin (e.g., a hyperparameter λ=1), a is the sigmoid function, and (hᵢ′, r, tᵢ′) is the i^{th} negative triplet. Moreover, the probability distribution of sampling negative triples may be defined by:

$$p ( ( {h}_{j}^{′} , r , {t}_{j}^{′} ) \vert \{ {h}_{j}^{′} , r , {t}_{j}^{′} \} ) = \frac{exp ( α {f}_{r} ( {h}_{j}^{′} , {t}_{j}^{′} ) )}{{\sum }_{i} exp ( α {f}_{r} ( {h}_{i}^{′} , {t}_{i}^{′} ) )} \qquad Formula 15$$

where α is the temperature of sampling.

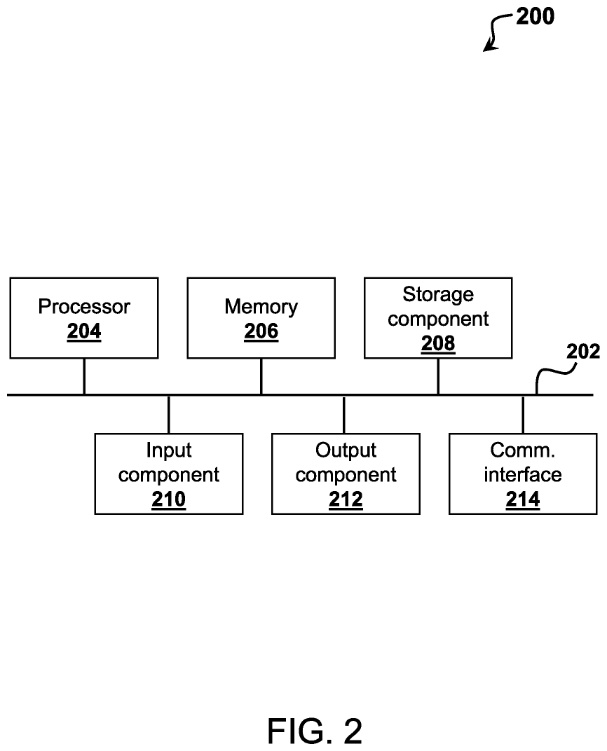

Referring now to FIG. 2, shown is a diagram of example components of device 200, according to non-limiting embodiments or aspects. Device 200 may correspond to modeling system 102, memory 104, computing device 106, and/or communication network 108, as an example. In some non-limiting embodiments or aspects, such systems or devices may include at least one device 200 and/or at least one component of device 200. The number and arrangement of components shown are provided as an example. In some non-limiting embodiments or aspects, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

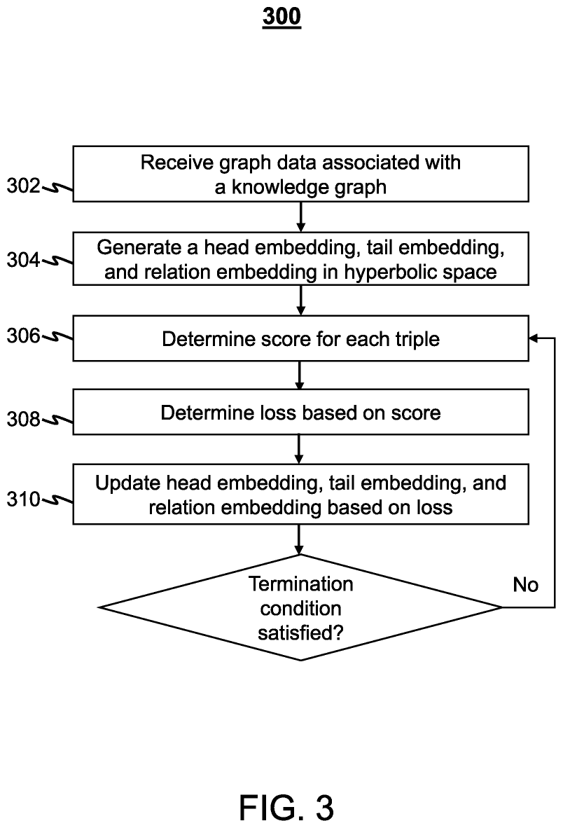

Referring now to FIG. 3, FIG. 3 is a flow diagram of a non-limiting embodiment or aspect of a process 300 for predictive modeling using hyperbolic knowledge graph embeddings, according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, one or more of the steps of process 300 may be performed (e.g., completely, partially, and/or the like) by modeling system 102. In some non-limiting embodiments or aspects, one or more of the steps of process 300 may be performed (e.g., completely, partially, and/or the like) by another system, another device, another group of systems, or another group of devices, separate from or including modeling system 102, such as memory 104 and/or computing device 106. In some non-limiting embodiments or aspects, a step may be automatically performed in response to performance and/or completion of a prior step.

As shown in FIG. 3, at step 302, process 300 may include receiving graph data associated with a knowledge graph. For example, modeling system 102 may receive graph data associated with a knowledge graph including a plurality of nodes and a plurality of edges. Each node of the plurality of nodes may be associated with an entity of a plurality of entities. Each edge of the plurality of edges may be associated with a relationship between at least two of the plurality of entities. The knowledge graph may include at least one triple. Each respective triple may include a respective head vector associated with a first respective entity of the plurality of entities, a respective tail vector associated with a second entity of the plurality of entities, and a respective relation vector associated with a respective relationship between the first respective entity and the second respective entity.

As shown in FIG. 3, at step 304, process 300 may include generating a head embedding, a tail embedding, and a relation embedding in a hyperbolic space. For example, modeling system 102 may generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple.

As shown in FIG. 3, at step 306, process 300 may include determining a score for each triple. For example, modeling system 102 may determine a respective score for each respective triple of the at least the subset of the at least one triple based on the respective head embedding, the respective tail embedding, and the respective relation embedding.

As shown in FIG. 3, at step 308, process 300 may include determining a loss based on the score. For example, modeling system 102 may determine a loss based on the respective score for each respective triple of the at least the subset of the at least one triple.

In some non-limiting embodiments or aspects, determining the loss may include at least one of generating (e.g., by modeling system 102) a recovered head embedding based on the respective tail embedding, the respective relation embedding, and/or the loss, or generating (e.g., by modeling system 102) a recovered tail embedding based on the respective head embedding, the respective relation embedding, and/or the loss. In either case, a respective head embedding or tail embedding may be recovered by using the computed loss function, and the representation of the triple may be updated by including the recovered embedding.

As shown in FIG. 3, at step 310, process 300 may include updating the head embedding, the tail embedding, and the relation embedding based on the loss. For example, modeling system 102 may update the respective head embedding, the respective tail embedding, and the respective relation embedding for each respective triple of the at least the subset of the at least one triple based on the loss.

In some non-limiting embodiments or aspects, process 300 may include repeating determining the respective score (e.g., step 306), determining the loss (e.g., step 308), and updating (e.g., step 310) until a termination condition is satisfied. For example, the termination condition may include a convergence of the loss, a target number of repetitions, and/or the like.

In some non-limiting embodiments or aspects, after the termination condition is satisfied (e.g., in response to the convergence of the loss), modeling system 102 may generate a prediction from a predictive model based on updating the respective head embedding, the respective tail embedding, and the respective relation embedding.

In some non-limiting embodiments or aspects, after the termination condition is satisfied (e.g., in response to the convergence of the loss), modeling system 102 may determine a new score for a new triple, which may include at least one of a new head vector, a new tail vector, and/or a new relation vector.

In some non-limiting embodiments or aspects, the graph data may be at least partly based on user interactions (e.g., access requests, downloads, transactions, etc.) of at least one user in a network. The prediction may be associated with a predicted relationship between a user of the at least one user and another entity in the network.

In some non-limiting embodiments or aspects, the plurality of entities may include a plurality of types of entities. The plurality of types of entities may include at least a user type entity and a network resource type entity. Relationships between user type entities and network resource type entities may be associated with access of a network resource by a user.

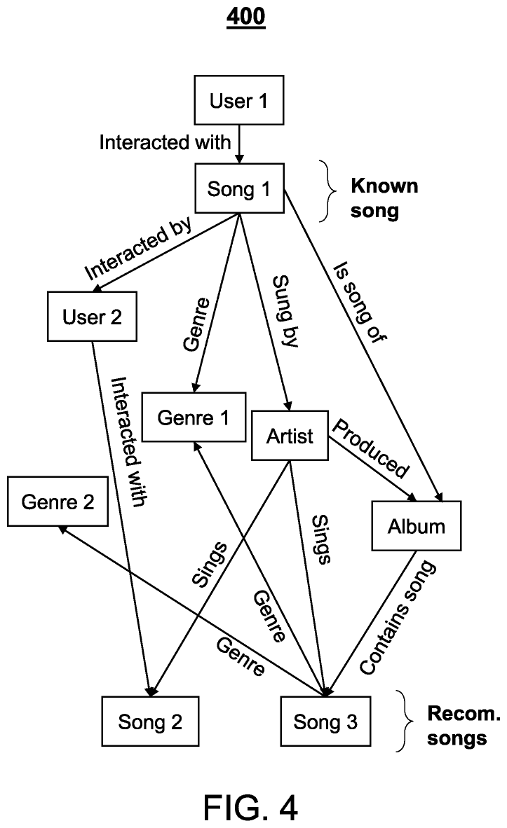

Referring now to FIG. 4, FIG. 4 is an illustrative knowledge graph 400, according to some non-limiting embodiments or aspects. Knowledge graph 400 is for illustrative purposes only and is not to be taken as limiting on the present disclosure. For ease of understanding, knowledge graph 400 is constructed from a domain of information related to music recommendations. For example, a first user (“User 1”) may be known to have interacted with a first song (“Song 1”). It may be the objective of modeling system 102 to recommend one or more other songs. Modeling system 102 may determine the one or more recommended songs based on knowledge graph 400.

As shown, knowledge graph 400 includes a plurality of nodes, represented by the labeled rectangles. Each node is associated with an entity of the domain that is being graphed. For example, nodes exist for users (User 1 and User 2), songs (Song 1, Song 2, and Song 3), genres (Genre 1 and Genre 2), an artist (Artist), and an album (Album). Each edge is associated with a relationship between at least two of the plurality of entities. For example, User 1 is connected by an edge to Song 1, and the edge is associated with the relationship of User 1 interacting with Song 1. By way of a further example, Song 1 is connected by an edge to Artist, and the edge is associated with the relationship of Song 1 being sung by Artist. By way of another example, Artist is connected by an edge to Album, and the edge is associated with the relationship of Artist producing Album. Each edge connecting two nodes in knowledge graph 400 is associated with a label describing the relationship between entities that the edge represents. The leading node at the non-arrow-side of an edge may be associated with a head vector, such that the information of the leading node may be included in the head vector. The following node at the arrow-side of an edge may be associated with a tail vector, such that the information of the following node may be included in the tail vector. The directional arrow of the edge may represent the relation vector.

Data of knowledge graph 400 may be received by modeling system 102. Modeling system 102 may then generate a respective embedding in hyperbolic space for each head vector, each tail vector, and each relation vector. Modeling system 102 may then determine a respective score for each triple based on the embeddings (see, e.g., Formula 13), and may further determine a loss based on the respective score for each triple (see, e.g., Formula 14). Modeling system 102 may update the embeddings for each triple based on the loss function, and repeat determining the scores, determining the losses, and updating the embeddings until a termination condition (e.g., convergence of the loss) is satisfied. In response to the termination condition, modeling system 102 may generate a prediction from a predictive model based on the updated embeddings. In the illustrated example, the prediction may be a recommended song (e.g., Song 2 or Song 3).

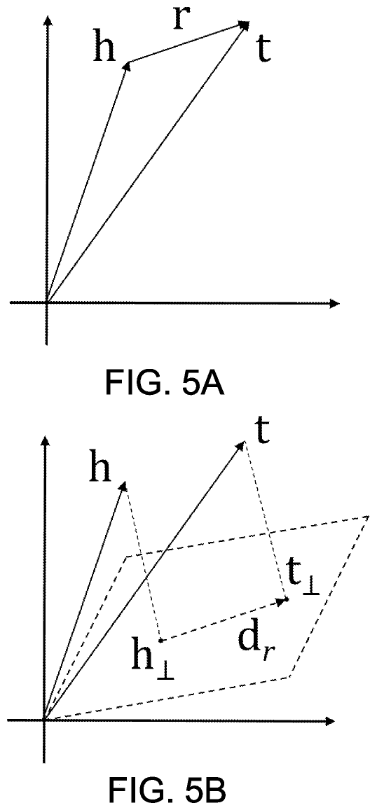

Referring now to FIGS. 5A and 5B, FIGS. 5A and 5B are illustrative examples of transforming a triple from Euclidean space to hyperbolic space. In particular, FIG. 5A depicts a first triple in Euclidean space. FIG. 5B depicts the same triple of FIG. 5A, but transformed into hyperbolic space. FIGS. 5A and 5B are provided for illustrative purposes only and are not to be taken as limiting on the present disclosure.

In some non-limiting embodiments or aspects, modeling system 102 may be configured to receive one or more triples, each triple including a head vector (h), a relation vector (r), and a tail vector (t). FIG. 5A depicts one such example triple. Modeling system 102 may generate embeddings of each triple, such that the head vector, relation vector, and tail vector are transformed from Euclidean space to hyperbolic space. FIG. 5B depicts the transformation of the triple from FIG. 5A into hyperbolic space, such that the head vector (h) becomes a head embedding (h⊥), the tail vector becomes a tail embedding (t⊥), and the relation vector (r) becomes the geodesic distance (dᵣ) between the head embedding (h⊥) and the tail embedding (t⊥).

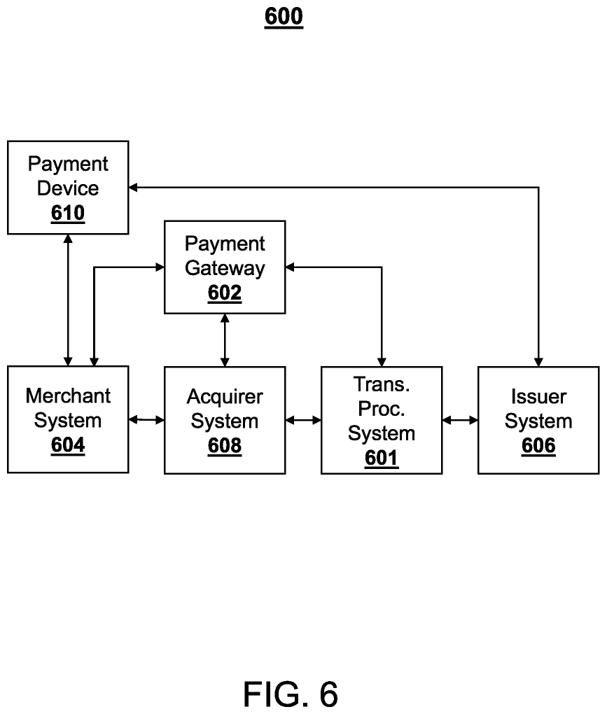

Referring now to FIG. 6, FIG. 6 is a schematic diagram of an electronic payment processing network 600, according to some non-limiting embodiments or aspects. Electronic payment processing network 600 may be used in conjunction with the systems and methods described herein. It will be appreciated that the particular arrangement of electronic payment processing network 600 shown is for example purposes only, and that various arrangements are possible. Transaction processing system 601 (e.g., a transaction handler) is shown to be in communication with one or more issuer systems (e.g., such as issuer system 606) and one or more acquirer systems (e.g., such as acquirer system 608). Although only a single issuer system 606 and single acquirer system 608 are shown, it will be appreciated that transaction processing system 601 may be in communication with a plurality of issuer systems and/or acquirer systems. In some non-limiting embodiments or aspects, transaction processing system 601 may also operate as an issuer system such that both transaction processing system 601 and issuer system 606 are a single system and/or controlled by a single entity. In some non-limiting embodiments or aspects, transaction processing system 601 may include or be included in modeling system 102.

In some non-limiting embodiments or aspects, transaction processing system 601 may communicate with merchant system 604 directly through a public or private network connection. Additionally or alternatively, transaction processing system 601 may communicate with merchant system 604 through payment gateway 602 and/or acquirer system 608. In some non-limiting embodiments or aspects, an acquirer system 608 associated with merchant system 604 may operate as payment gateway 602 to facilitate the communication of transaction requests from merchant system 604 to transaction processing system 601. Merchant system 604 may communicate with payment gateway 602 through a public or private network connection. For example, a merchant system 604 that includes a physical POS device may communicate with payment gateway 602 through a public or private network to conduct card-present transactions. As another example, a merchant system 604 that includes a server (e.g., a web server) may communicate with payment gateway 602 through a public or private network, such as a public Internet connection, to conduct card-not-present transactions.

In some non-limiting embodiments or aspects, transaction processing system 601, after receiving a transaction request from merchant system 604 that identifies an account identifier of a payor (e.g., such as an account holder) associated with an issued payment device 610, may generate an authorization request message to be communicated to issuer system 606 that issued payment device 610 and/or account identifier. Issuer system 606 may then approve or decline the authorization request and, based on the approval or denial, generate an authorization response message that is communicated to transaction processing system 601e Transaction processing system 601 may communicate an approval or denial to merchant system 604. When issuer system 606 approves the authorization request message, it may then clear and settle the payment transaction between issuer system 606 and acquirer system 608.

In some non-limiting embodiments or aspects, system 100 of FIG. 1 may include, or be included in, electronic payment processing network 600. For example, the transaction data (e.g., including various parameters, such as PAN, payment device identifier, merchant identifier, user identifier, transaction amount, transaction date, transaction time, transaction description, transaction type, merchant category code, etc.) of transactions processed by transaction processing system 601 may be used in the triples of the knowledge graph for modeling system 102. By way of further example, a first value of a parameter of the transaction data (e.g., a merchant identifier of a processed transaction) may be associated with a first head vector of a first triple, a second value of a parameter of the transaction data (e.g., a transaction type of the processed transaction) may be associated with a first tail vector of the first triple, and a relation between the first parameter and the second parameter (e.g., the merchant configured for card-not-present transaction type) may be associated with the relation vector of the first triple. A plurality of triples may be generated accordingly using a plurality of transaction data parameters.

The described methods and systems may use the transaction data of the knowledge graph as input to generate one or more transaction-related predictions, such as fraudulent transactions that were processed, recommended transactions for a user to engage in, relationships between payment users in the electronic payment processing network 600, and/or the like.

Although embodiments or aspects have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
at least one processor configured to:
receive graph data associated with a knowledge graph comprising a plurality of nodes and a plurality of edges, each node of the plurality of nodes associated with an entity of a plurality of entities, each edge of the plurality of edges associated with a relationship between at least two of the plurality of entities, the knowledge graph comprising at least one triple, each respective triple comprising a respective head vector associated with a first respective entity of the plurality of entities, a respective tail vector associated with a second entity of the plurality of entities, and a respective relation vector associated with a respective relationship between the first respective entity and the second respective entity;
generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple;
determine a respective score for each respective triple of the at least the subset of the at least one triple based on the respective head embedding, the respective tail embedding, and the respective relation embedding;
determine a loss based on the respective score for each respective triple of the at least the subset of the at least one triple;
update the respective head embedding, the respective tail embedding, and the respective relation embedding for each respective triple of the at least the subset of the at least one triple based on the loss; and
repeat determining the respective score, determining the loss, and updating until a termination condition is satisfied.

2. The system of claim 1, wherein, when determining the loss, the at least one processor is configured to, at least one of:
generate a recovered head embedding based on the respective tail embedding, the respective relation embedding, and the loss; or
generate a recovered tail embedding based on the respective head embedding, the respective relation embedding, and the loss.

3. The system of claim 1, wherein the termination condition is a convergence of the loss.

4. The system of claim 3, wherein the at least one processor is further configured to, in response to the convergence of the loss, generate a prediction from a predictive model based on updating the respective head embedding, the respective tail embedding, and the respective relation embedding.

5. The system of claim 3, wherein the at least one processor is further configured to, in response to the convergence of the loss, determine a new score for a new triple comprising at least one of a new head vector, a new tail vector, or a new relation vector.

6. The system of claim 4, wherein the graph data is at least partly based on user interactions of at least one user in a network, and wherein the prediction is associated with a predicted relationship between a user of the at least one user and another entity in the network.

7. The system of claim 6, wherein the plurality of entities comprise a plurality of types of entities, the plurality of types of entities comprising at least a user type entity and a network resource type entity, wherein relationships between user type entities and network resource type entities are associated with access of a network resource by a user.

8. A computer-implemented method comprising:
receiving, with at least one processor, graph data associated with a knowledge graph comprising a plurality of nodes and a plurality of edges, each node of the plurality of nodes associated with an entity of a plurality of entities, each edge of the plurality of edges associated with a relationship between at least two of the plurality of entities, the knowledge graph comprising at least one triple, each respective triple comprising a respective head vector associated with a first respective entity of the plurality of entities, a respective tail vector associated with a second entity of the plurality of entities, and a respective relation vector associated with a respective relationship between the first respective entity and the second respective entity;
generating, with at least one processor, a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple;
determining, with at least one processor, a respective score for each respective triple of the at least the subset of the at least one triple based on the respective head embedding, the respective tail embedding, and the respective relation embedding;
determining, with at least one processor, a loss based on the respective score for each respective triple of the at least the subset of the at least one triple;
updating, with at least one processor, the respective head embedding, the respective tail embedding, and the respective relation embedding for each respective triple of the at least the subset of the at least one triple based on the loss; and
repeating, with at least one processor, determining the respective score, determining the loss, and updating until a termination condition is satisfied.

9. The method of claim 8, wherein determining the loss comprises at least one of:
generating, with at least one processor, a recovered head embedding based on the respective tail embedding, the respective relation embedding, and the loss; or
generating, with at least one processor, a recovered tail embedding based on the respective head embedding, the respective relation embedding, and the loss.

10. The method of claim 8, wherein the termination condition is a convergence of the loss.

11. The method of claim 10, further comprising, in response to the convergence of the loss, generating, with at least one processor, a prediction from a predictive model based on updating the respective head embedding, the respective tail embedding, and the respective relation embedding.

12. The method of claim 10, further comprising, in response to the convergence of the loss, determining, with at least one processor, a new score for a new triple comprising at least one of a new head vector, a new tail vector, or a new relation vector.

13. The method of claim 11, wherein the graph data is at least partly based on user interactions of at least one user in a networked system, and wherein the prediction is associated with a predicted relationship between a user of the at least one user and another entity in the networked system.

14. The method of claim 13, wherein the plurality of entities comprise a plurality of types of entities, the plurality of types of entities comprising at least a user type entity and a network resource type entity, wherein relationships between user type entities and network resource type entities are associated with access of a network resource by a user.

15. A computer program product comprising at least one non-transitory computer-readable medium comprising program instructions that, when executed by at least one processor, cause the at least one processor to:
receive graph data associated with a knowledge graph comprising a plurality of nodes and a plurality of edges, each node of the plurality of nodes associated with an entity of a plurality of entities, each edge of the plurality of edges associated with a relationship between at least two of the plurality of entities, the knowledge graph comprising at least one triple, each respective triple comprising a respective head vector associated with a first respective entity of the plurality of entities, a respective tail vector associated with a second entity of the plurality of entities, and a respective relation vector associated with a respective relationship between the first respective entity and the second respective entity;
generate a respective head embedding in a hyperbolic space for each respective head vector of at least a subset of the at least one triple, a respective tail embedding in the hyperbolic space for each respective tail vector of the at least the subset of the at least one triple, and a respective relation embedding in the hyperbolic space for each respective relation vector of the at least the subset of the at least one triple;
determine a respective score for each respective triple of the at least the subset of the at least one triple based on the respective head embedding, the respective tail embedding, and the respective relation embedding;
determine a loss based on the respective score for each respective triple of the at least the subset of the at least one triple;
update the respective head embedding, the respective tail embedding, and the respective relation embedding for each respective triple of the at least the subset of the at least one triple based on the loss; and
repeat determining the respective score, determining the loss, and updating until a termination condition is satisfied.

16. The computer program product of claim 15, wherein the program instructions that cause the at least one processor to determine the loss cause the at least one processor to, at least one of:
generate a recovered head embedding based on the respective tail embedding, the respective relation embedding, and the loss; or
generate a recovered tail embedding based on the respective head embedding, the respective relation embedding, and the loss.

17. The computer program product of claim 15, wherein the termination condition is a convergence of the loss.

18. The computer program product of claim 17, wherein the program instructions further cause the at least one processor to, in response to the convergence of the loss, generate a prediction from a predictive model based on updating the respective head embedding, the respective tail embedding, and the respective relation embedding.

19. The computer program product of claim 17, wherein the program instructions further cause the at least one processor to, in response to the convergence of the loss, determine a new score for a new triple comprising at least one of a new head vector, a new tail vector, or a new relation vector.

20. The computer program product of claim 18, wherein the graph data is at least partly based on user interactions of at least one user in a network, and wherein the prediction is associated with a predicted relationship between a user of the at least one user and another entity in the network.
